(19) United States
(12) Patent Application Publication
(10) Pub. No.: US 2008/0204836 A1
(43) Pub. Date: Aug. 28, 2008

(54) HOLOGRAPHIC OPTICAL ELEMENT AND COMPATIBLE OPTICAL PICKUP DEVICE INCLUDING THE SAME

(75) Inventors: Jae-cheol BAE, Suwon-si (KR); Tae-kyung Kim, Seoul (KR); Kyong-tae Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/957,577

(22) Filed: Dec. 17, 2007

(30) Foreign Application Priority Data
Jan. 30, 2007 (KR) 2007-9546

(51) Int. Cl. G02B 5/32

(52) U.S. Cl. 359/15

(57) ABSTRACT

An optical pickup device is compatible with first and second information storage media having different thickness, and includes a light source to emit light; a holographic optical element having holograms in regions to diffract the light into a zero-order diffraction light beam and a first-order diffraction light beam, including a first region to transmit the zero-order diffraction light beam in a straight direction and to diverge the first-order diffraction light beam, a second region to transmit the zero-order diffraction light beam in the straight direction and to converge the first-order diffraction light beam, and a third region to transmit the zero-order diffraction light beam in the straight direction and to converge the first-order diffraction light beam, wherein the zero-order diffraction efficiency of the third region is different from the zero-order diffraction efficiency of the second region; and an objective lens to focus the light to the information storage media.

### CROSS-REFERENCE TO RELATED APPLICATION

This application claims all benefits accruing under 35 U.S.C. §119 from Korean Patent Application No. 2007-9546, filed on Jan. 30, 2007, in the Korean Intellectual Property Office, the disclosure of which is incorporated herein by reference.

### BACKGROUND OF THE INVENTION

1. Field of the Invention

Aspects of the present invention relate to a holographic lens unit having a plurality of hologram regions and a compatible optical pickup device including the hologram lens unit, and more particularly, to a hologram lens unit which uses a light source and is compatible with optical information storage media having different thicknesses, and a compatible optical pickup device including the holographic lens unit.

2. Description of the Related Art

An optical recording and/or reproducing device records and/or reproduces information to and/or from an information storage medium, such as an optical disk, using laser light which is focused into optical spots by an objective lens. The amount of information recorded and/or reproduced is determined by the size of the focused optical spots. The size of the focused optical spots is determined by the wavelength (λ) of the laser light and the numerical aperture (NA) of the objective lens, and is proportional to λ/NA. Accordingly, to increase the recording capacity of the optical disk, the size of the optical spots formed on the optical disk should be reduced and the numerical aperture should be increased. To this end, a short-wavelength light source, such as blue laser, and an objective lens having a high NA should be employed.

Presently, a blu-ray disk (BD) has a surface recording capacity of about 25 GB, is used with a light source at a wavelength of around 405 nm, and an objective lens having a NA of 0.85. BDs have a thickness of 0.1 mm. Also, a high definition-DVD (HD-DVD) has a surface capacity of about 15 GB, uses the same wavelength as the BD standard, and uses an objective lens having an NA of 0.65. HD-DVDs have a thickness of 0.6 mm. Since both the BD standard for optical disks of about 25 GB and the HD-DVD standard for optical disks of about 15 GB are currently being used, devices to record and/or reproduce information to and/or from these high density optical disks should be compatible with both optical disk standards.

The BD and HD-DVD standards require the use of different objective lenses. Accordingly, devices compatible with both standards have been developed using two objective lenses and corresponding optical components. However, these devices require more optical components, which increase the manufacturing costs and complicate the control of optical axes between the objective lenses.

To solve the above problem, devices have been developed which require only a single objective lens and reduce spherical aberration by using a holographic optical element. Japanese Patent Laid-Open Publication No. Hei 08-062493 discloses a method of using different CD-based optical disks when using a DVD light source. FIG. 1 shows an optical disk device illustrated in the above publication. Referring to FIG. 1, a hologram lens 107 includes a first region 107a which transmits a zero-order diffraction light beam in a straight direction and diverges a first-order diffraction light beam, and a second region 107b which transmits the zero-order diffraction light beam in a straight direction and converges the first-order diffraction light beam. The first region 107a forms one focal point using the first-order diffraction light beam as straight light beams, and the second region 107b forms another focal point at a different focal length using the first-order diffraction light beams as divergent light beams. In other words, the first-order diffraction light beam transmitted through the first region 107a is used to focus optical spots on an optical disk having a greater thickness, and the zero-order diffraction light beam transmitted through the first region 107a and the second region 107b are used to form optical spots on an optical disk having a smaller thickness.

The first region 107a is formed so that the zero-order diffraction light beam and the first-order diffraction light beam have the same diffraction efficiency. The second region 107b is formed so that the zero-order diffraction light beam and the first-order diffraction light beam have the same or different diffraction efficiencies. The diffraction efficiency of the first-order diffraction light beam transmitted through the second region 107b may be increased to increase the optical efficiency of optical spots focused on the optical disk having a smaller thickness.

Meanwhile, the diffraction efficiency affects the jitter characteristics. FIG. 2 is a graph showing the jitter characteristics according to the diffraction efficiency of the second region 107b. The graph shows the jitter characteristics of the second region 107b according to the diffraction efficiency of the first-order diffraction light when the diffraction efficiency of the first region 107a is 40%. Referring to the graph of FIG. 2, the maximum diffraction efficiency is approximately 50% within the range in which the jitter is not deteriorated, That is, with respect to the jitter characteristics, the increase in optical efficiency is limited.

### SUMMARY OF THE INVENTION

Aspects of the present invention provide a holographic optical element having a plurality of hologram regions, and a compatible optical pick device including the optical element and having a higher optical efficiency than conventional compatible optical pick up devices.

Additional aspects and/or advantages of the invention will be set forth in part in the description which follows and, in part, will be obvious from the description, or may be learned by practice of the invention.

An example embodiment of the present invention provides a holographic optical element having holograms to diffract light into a zero-order diffraction light and a first-order diffraction light beam, the holographic optical element including a first region to transmit the zero-order diffraction light beam in a straight direction and to diverge the first-order diffraction light beam, a second region to transmit the zero-order diffraction light beam in the straight direction and to converge the first-order diffraction light beam, and a third region to transmit the zero-order diffraction light beam in the straight direction and to converge the first-order diffraction light beam, wherein a zero-order diffraction efficiency of the third region is different from a zero-order diffraction efficiency of the second region.

Another example embodiment of the present invention provides a compatible optical pickup device compatible with a first information storage medium and a second information storage medium having different thicknesses, including a light source to emit light, a holographic optical element having holograms in regions to diffract the light emitted from the light source into a zero-order diffraction light beam and a first-order diffraction light beam, and including a first region to transmit the zero-order diffraction light beam in a straight direction and to diverge the first-order diffraction light beam, a second region to transmit the zero-order diffraction light beam in the straight direction and to converge the first-order diffraction light beam, and a third region to transmit the zero-order diffraction light beam in the straight direction and to converge the first-order diffraction light beam, wherein a zero-order diffraction efficiency of the third region is different from a zero-order diffraction efficiency of the second region, and an objective lens to focus the light to the first information storage medium and the second information storage medium, wherein the zero-order diffraction light beam passing through the holographic optical element is focused on the first information storage medium, and the first-order diffraction light beam diverging from the first region of the holographic optical element is focused on the second information storage medium.

Another example embodiment of the present invention provides a compatible optical pickup device compatible with a first information storage medium and a second information storage medium having different thickness, including a light source to emit light, and an objective lens to focus the light emitted from the light source on the first information storage medium and the second information storage medium, wherein a holographic optical element is formed on a surface of the objective lens in regions to diffract the light into a zero-order diffraction light beam and a first-order diffraction light beam, the holographic optical element including a first region to transmit the zero-order diffraction light beam in a straight direction and to diverge the first-order diffraction light beam, a second region to transmit the zero-order diffraction light beam in the straight direction and to converge the first-order diffraction light beam, and a third region to transmit the zero-order diffraction light beam in the straight direction and to converge the first-order diffraction light beam, wherein a zero-order diffraction efficiency of the third region is different from a zero-order diffraction efficiency of the second region, the zero-order diffraction light beam passing through the holographic optical element is focused on the first information storage medium, and the first-order diffraction light beam diverging from the first region of the holographic optical element is focused on the second information storage medium.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a schematic view illustrating an optical disk device including a conventional hologram lens;

FIG. 2 is a graph showing jitter characteristics according to the diffraction efficiency of a second region of the hologram lens shown in FIG. 1;

FIG. 3 is a schematic view illustrating a compatible optical pickup device according to an example embodiment of the present invention;

FIG. 4 illustrates optical paths in the case where two types of information storage media are used in the compatible optical pickup device shown in FIG. 3;

FIG. 5A illustrates a holographic optical element used in the compatible optical pickup device, the holographic optical element including a plurality of regions divided by several concentric circles;

FIG. 5B illustrates a plurality of steps on a light-incident surface of holograms of the holographic optical element shown in FIG. 5A;

FIG. 6 is a graph showing diffraction efficiencies of a zero-order diffraction light beam and a first-order diffraction light beam according to the depth of the holograms of the holographic optical element shown in FIG. 5A;

FIG. 7 is a graph showing jitter characteristics according to the diffraction efficiency of a third region in the holographic optical element shown in FIG. 5A;

FIG. 8 is a graph showing jitter characteristics according to phase differences in the holographic optical element shown in FIG. 5A;

FIGS. 9 and 10 are graphs showing reproduction signals when a conventional hologram lens is used in the case where the diffraction efficiency of the first and second regions are 40% and 50%, and 40% and 40%, respectively;

FIG. 11 is a graph showing reproduction signals generated by the compatible optical pickup device shown in FIG. 3;

FIG. 12 is a schematic view illustrating a compatible optical pickup device according to another embodiment of the present invention; and

FIG. 13 illustrates optical paths in the case where two types of information storage media are used in the compatible optical pickup device shown in FIG. 12.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

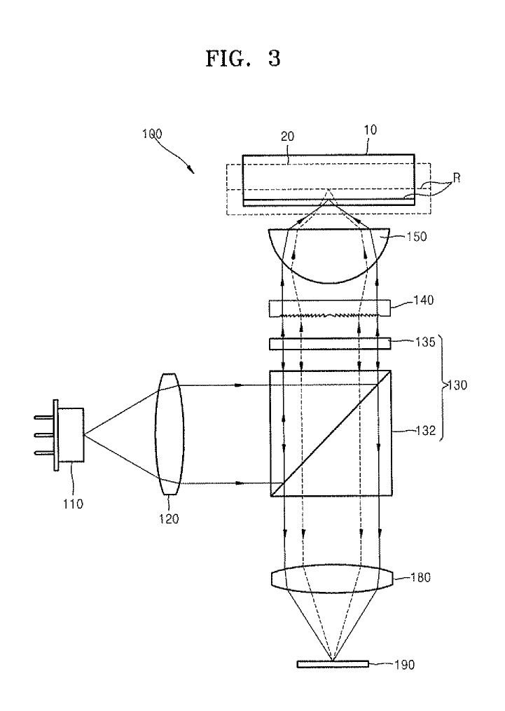

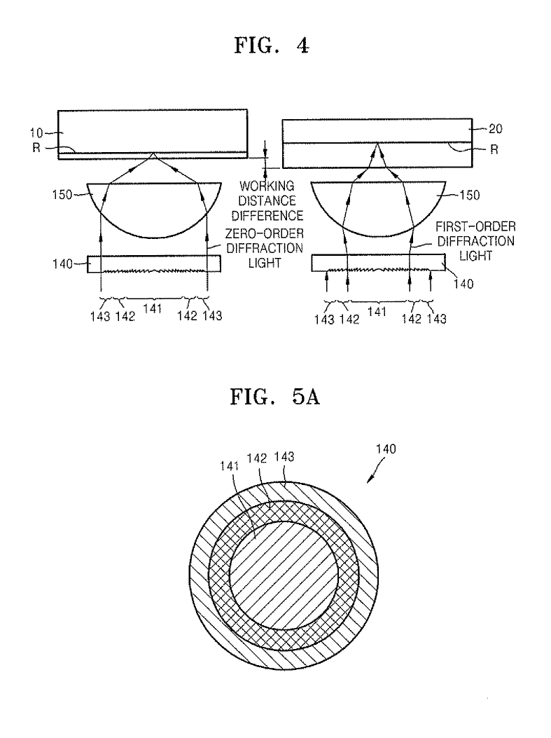

FIG. 3 is a schematic view illustrating a compatible optical pickup device 100 according to an example embodiment of the present invention. FIG. 4 illustrates optical paths in the case where two types of information storage media are used in the compatible optical pickup device shown in FIG. 3.

Referring to FIGS. 3 and 4, the compatible optical pickup device 100 is compatible with a first information storage medium 10 and a second information storage medium 20. Such an optical pickup device 100 includes a light source 110 to emit light having a predetermined wavelength, a holographic optical element 140 including holograms to diffract light emitted from the light source 110 into zero-order diffraction light beams and first-order diffraction light beams and having a plurality of regions 141, 142, and 143, and an objective lens 150 to focus the light to the first and second information storage media 10 and 20. A zero-order diffraction light beam transmitted by the holographic optical element 140 is focused on the first information storage medium 10, and a first-order diffraction light beam transmitted by the holographic optical element 140 is focused on the second information storage medium 20.

The first and second information storage media 10 and 20 have different thicknesses, and comply with standards using light having the same wavelength. The thicknesses of the first and second information storage media 10 and 20 refers to the distances between light incident surfaces and recording layers R. According to an aspect of the present invention, the first information storage medium 10 may comply with the Blu-ray disk (BD) standard, and the second information storage medium 20 may comply with the high definition-DVD (HD-DVD) standard. However, it is understood that the first and second information storage media 10 and 20 are not limited to complying with the BD and HD-DVD standard, any may instead comply with any kinds of standards which use substantially the same wavelength during recording and reproducing operations.

The light source 110 emits light having a wavelength which is used for both the first information storage medium 10, for example, a BD, and the second information storage medium 20, for example, an HD-DVD, which has a different thickness from the first information storage medium 10. In this case, the light source 110 emits blue light having a wavelength of approximately 405 nm. According to an aspect of the present invention, the light source 110 may be a semiconductor laser source. However, the light source 110 may also be other types of lasers.

The holographic optical element 140 separates and focuses light emitted from the light source 110 to the first information storage medium 10 and the second information storage medium 20. To this end, the holographic optical element 140 includes a first region 141 having a hologram through which a zero-order diffraction light beam is transmitted straight through and a first-order diffraction light beam is diverged, a second region 142 having a hologram through which a zero-order diffraction light beam is transmitted straight through and a first-order diffraction light beam is converged, and a third region 143 having a hologram through which zero-order diffraction light beam is transmitted straight through and first-order diffraction light beam is converged. According to an aspect of the present invention, the third region 143 has a different zero-order diffraction efficiency from the zero-order diffraction efficiency of the second region 142. The form of the holograms will be described in more detail later.

The objective lens 150 focuses the light beams that are diffracted as a zero-order diffraction light beam and a first-order diffraction light beam by the holographic optical element 140 onto the first information storage medium 10 and the second information storage medium 20. The zero-order diffraction light beam passes through the first through third regions 141, 142, and 143 of the holographic optical element 140 in a straight direction and is focused by the objective lens 150 on the recording layer R of the first information storage medium 10. In the case of a first-order diffraction light beam, only light passing through the first region 141 of the holographic optical element 140 reaches the objective lens 150 through a relatively small entrance pupil, and is then focused on the recording layer R of the second information storage medium 20 which has a greater thickness than the first information storage medium 10.

Also, the compatible optical pickup device 100 includes an optical path converting unit 130 to convert the path of incident light, and an optical detector 190 to detect light reflected by the first and second information storage media 10 and 20 after the light has reflected off the first and second information storage media 10 and 20 and passed through the objective lens 150. The compatible optical pickup device 100 and the optical path converting unit 130 are disposed in an optical path between the light source 110 and the objective lens 150. A collimating lens 120 to collimate divergent light emitted from the light source 110 into parallel light is disposed in the optical path between the light source 110 and the objective lens 150. In addition, a sensor lens 180 is disposed in an optical path between the optical path converting unit 130 and the optical detector 190 so that light which is reflected by the first and second information storage media 10 and 20 is received by the optical detector 190 as optical spots having a proper size. The sensor lens 180 is an astigmatic lens to detect focus error signals by an astigmatic method. The optical path converting unit 130 includes a polarization beam splitter 132 and a quarter wavelength plate 135. It is understood that some of the elements may be omitted from the compatible optical pickup device 100, for example, the sensor lens 180.

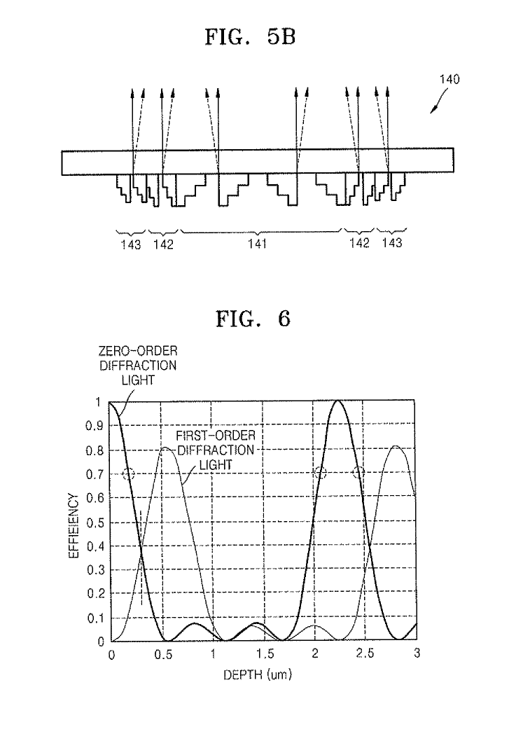

FIG. 5A illustrates first, second, and third regions 141, 142, and 143 of the holographic optical element 140. FIG. 5B illustrates the form of hologram patterns formed in the first through third regions 141, 142, and 143 of the holographic optical element 140. Referring to FIGS. 5A and 5B, holograms to modulate phases by diffraction, for example, holograms formed concentrically and in a relief pattern, are formed in the first through third regions 141, 142, and 143. A hologram is formed in the first region 141 to transmit a zero-order diffraction light beam in a straight direction and to diverge a first-order diffraction light beam. In FIG. 5B, the zero-order diffraction light beam is illustrated with a solid line, and the first-order diffraction light beam is illustrated with a dotted line. The hologram has a light-incident surface formed as a plurality of steps, as illustrated in FIG. 5B.

A hologram is formed in the second region 142 to transmit the zero-order diffraction light beam in a straight direction and to converge the first-order diffraction light beam. The hologram of the second region 142 also has a light-incident surface formed as a plurality of steps, as illustrated in FIG. 5B. The direction of the steps of the second region 142 is opposite to the direction of the steps of the first region 141. Also, the depth of the holograms is determined considering the diffraction efficiency. In FIG. 5B, the hologram in the second region 142 is formed with the same depth as in the first region, but the holograms in the second region 142 may be formed lower or higher than the steps of the first region 141 according to other aspects of the present invention.

A hologram is formed in the third region 143 to transmit the zero-order diffraction light beam and to converge the first-order diffraction light beam. The hologram of the third region 143 may have a light-incident surface shaped as a plurality of steps, as illustrated in FIG. 5B, but is not limited thereto. When the third region 143 is provided with steps, the steps are oriented in the same direction as the steps of the hologram in the second region 142, according to an aspect of the present invention. The diffraction efficiency of the third region 143 is different from the diffraction efficiency of the second region 142. That is, the depth of the hologram of the third region 143 is different from the depth of the hologram of the second region 142. For example, the depth of the hologram of the third region 143 is smaller than the depth of the hologram of the second region 142. Alternatively, the depth of the hologram of the third region 143 may be larger than the depth of the hologram of the second region 142.

The depths of the holograms formed in the first through third regions 141, 142, and 143 are determined in consideration of diffraction efficiency and jitter characteristics, as described below with reference to FIGS. 6 through 8.

FIG. 6 is a graph showing diffraction efficiencies of a zero-order diffraction light beam and a first-order diffraction light beam according to the depth of a hologram. The holograms used according to aspects of the present invention are formed of a material having a refractive index of 1.52 with respect to blue light having a wavelength of about 405 nm, and have four steps, although other types of holograms may be used which have different refractive indices and work with different wavelengths. Referring to FIG. 6, the diffraction efficiency is approximately 40% when zero-order and first-order diffraction efficiencies are the same. Since both the zero-order and first-order diffraction light beams transmitted through the first region 141 are effective to record and/or reproduce data, the diffraction efficiencies may be the same. For example, in the first region 141, a hologram may be formed at a depth where zero-order and first-order diffraction efficiencies are approximately 40%. The depth of the hologram is approximately 0.3 μm. It is understood, however, that the zero-order and first-order diffraction efficiencies in the first region 141 and the second region 142 are not limited to being the same. Furthermore, the depth of the hologram may be more or less than 0.3 μm.

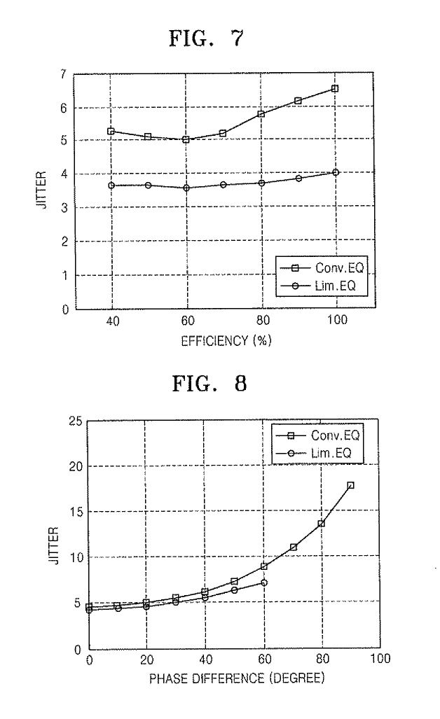

FIG. 7 is a graph showing the jitter characteristics according to the diffraction efficiency of the third region 143. The graph of FIG. 7 shows the jitter characteristics according to the increase in the zero-order diffraction efficiency of the third region 143 when the zero-order diffraction efficiency of the first region 141 and the second region 142 is 40%. Referring to the graph of FIG. 7, the range in which the jitter characteristics do not deteriorate beyond a maximum allowable jitter level is at any level of efficiency lower than approximately 70%, and thus the efficiency of the third region 143 may be increased up to 70%. As shown in FIG. 7, the maximum allowable jitter level is approximately around level 6 on the graph, although may be adjusted higher or lower than the level 6. Referring to FIG. 6, the zero-order diffraction light has 70% efficiency in the hologram when the hologram is formed to depths of 0.2 μm, 2.1 μm, or 2.4 μm. Accordingly the depth of the hologram of the third region 143 is approximately 0.2 μm, which is a smaller depth than the depth of the hologram of the second region 142. Thus, a zero-order diffraction efficiency of the third region 143 is based on jitter characteristics of the third region 143. Alternatively, depending on manufacturing conditions, the hologram of the third region 143 may be formed to depths of approximately 2.1 or 2.4 μm.

Since the phase shift of light is different according to the depth of the hologram, light transmitting holograms which have different depths may have phase differences. FIG. 8 is a graph showing the jitter characteristics according to phase differences. Referring to the graph of FIG. 8, when the phase difference is great, the jitter characteristics deteriorate, and thus, the diffraction efficiency or the depth of the third region 143 may be determined within the range where the phase difference between the light transmitted through the second region 142 and the light passing through the third region 143 is smaller than about 200. However, it is understood that the diffraction efficiency or the depth of the third region 143 is not limited to being determined within this range, and may instead be determined in a range where the phase difference is greater than 20°.

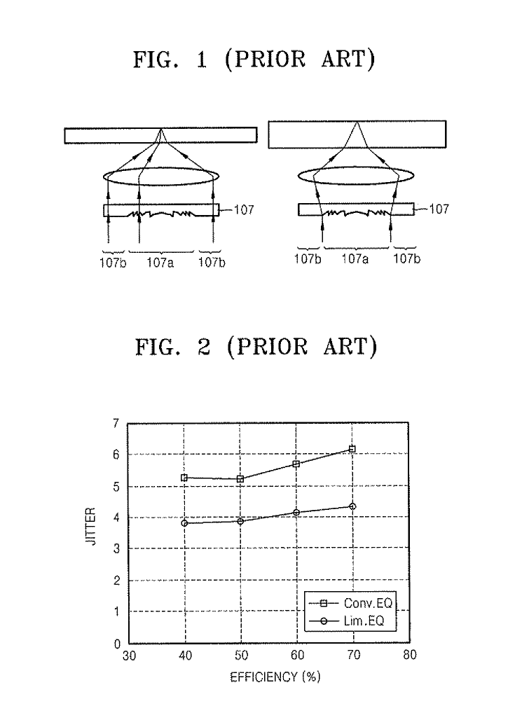

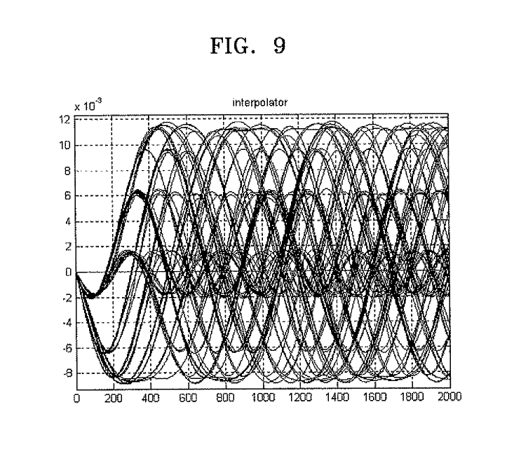

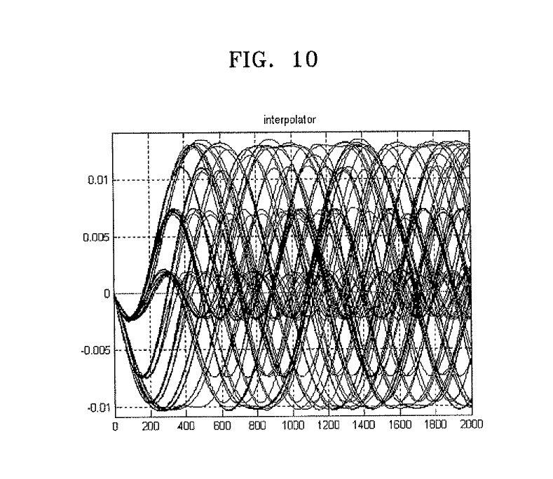

FIGS. 9 and 10 are graphs showing reproduction signals at RF levels in a conventional optical pickup device employing a conventional hologram lens, such as the conventional hologram lens 107 shown in FIG. 1. In FIG. 9, the diffraction efficiencies of the first and second regions are 40% and 50%, respectively. In FIG. 10, the diffraction efficiencies of the first and second regions are 40% and 40%, respectively. When the diffraction efficiency of the second region is greater, as shown in FIG. 9, the reproduction signals are higher by approximately 20%. However, the diffraction efficiency of the second region should not be increased by more than 20% because of the deterioration of the jitter performance, as described before with reference to FIG. 8.

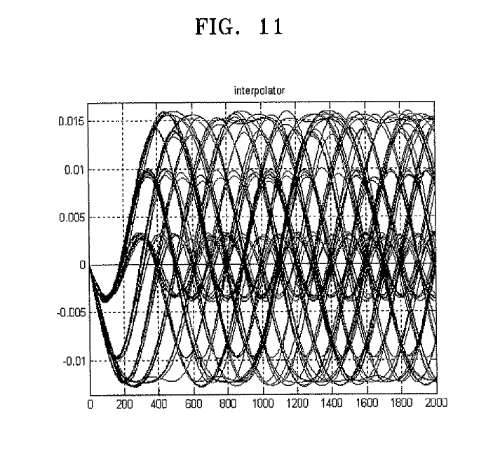

FIG. 11 is a graph showing reproduction signals generated by the compatible optical pickup device shown in FIG. 3. In FIG, 11, the diffraction efficiencies of the first through third regions 141, 142, and 143 are 40%, 40%, and 70%, respectively. Referring to FIG. 11, the reproduction signals are increased by about 34% compared to the reproduction signals shown in FIG, 9. This increase is obtained by properly determining the efficiency and function of the third region 142 in the holographic optical element 140 having the above described-structure.

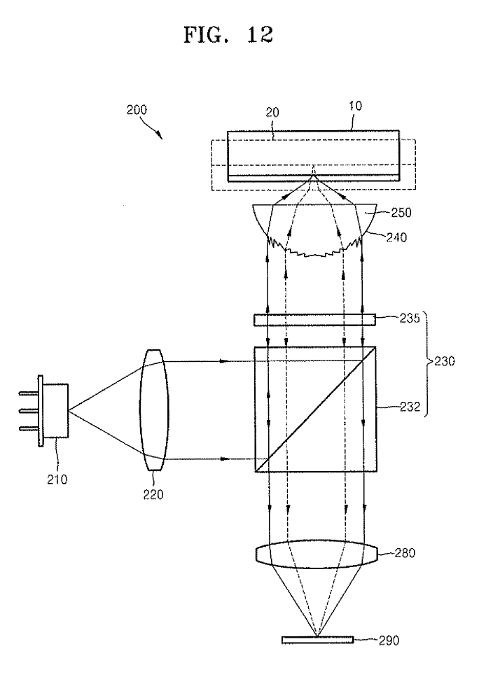

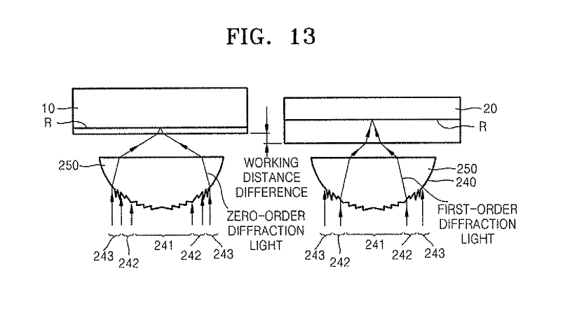

FIG. 12 is a schematic view illustrating a compatible optical pickup device 200 according to another embodiment of the present invention. FIG. 13 illustrates optical paths in the case where two types of information storage media are used in the compatible optical pickup device 200 shown in FIG. 12. Referring to FIGS. 12 and 13, since the compatible optical pickup device 200 is compatible with the first and the second information storage media 10 and 20, the compatible optical pickup device 200 includes a light source 210 to emit light having a predetermined wavelength and an objective lens 250 to focus the light emitted from the light source 210 to the first and second information storage media 10 and 20. A holographic optical element 240 is formed on a surface of the objective lens 250 and includes a plurality of regions 241, 242, and 243, in which holograms diffracting light into a zero-order diffraction light beam or a first-order diffraction light beam are formed. The form of the regions 241, 242, and 243 of the holographic optical element 240 and the form of the holograms formed in the regions 241, 242, and 243 are substantially similar to those illustrated in FIGS. 5A and 5B, and thus a detailed description thereof will not be repeated.

In addition, the compatible optical pickup device 200 includes a collimating lens 220, an optical path converting unit 230 including a polarization beam splitter 232 and a quarter wavelength plate 235, a sensor lens 280, and an optical detector 290. These elements are substantially similar to elements illustrated in FIG. 2, and thus a detailed description thereof will not be repeated. Unlike the holographic optical element 140 illustrated in FIG. 3, the compatible optical pickup device 200 is characteristic in that the holographic optical element 240 is formed on a surface of the objective lens 250, instead of separately like the holographic optical element 140. Thus, the compatible optical pickup device 200 has a very simple design and is compatible with the first and second information storage media 10 and 20.

As described above, the holographic optical elements 140 and 240 according to aspects of the present invention include a plurality of holographic regions. Thus, aspects of the present invention improve diffraction efficiencies of the regions, and efficiently separate light for recording and/or reproducing operations. Accordingly, the compatible optical pickup devices 100 and 200, which respectively include the holographic optical elements 140 and 240, only require a single light source, are compatible with various types of information storage media, and increase optical efficiency without deterioration of the recording and/or reproduction performance.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the first, second, and third regions 141, 142, and 143 may be varied in relative sizes (FIG. 5a), relative depths (FIG. 6), and relative step directions (FIG. 5B). Accordingly, it is intended, therefore, that the present invention not be limited to the various example embodiments disclosed, but that the present invention includes all embodiments failing within the scope of the appended claims.

What is claimed is:

1. A holographic optical element having holograms in regions to diffract light into a zero-order diffraction light beam and a first-order diffraction light beam, the holographic optical element comprising:
a first region to transmit the zero-order diffraction light beam in a straight direction and to diverge the first-order diffraction light beam;
a second region to transmit the zero-order diffraction light beam in the straight direction and to converge the first-order diffraction light beam; and
a third region to transmit the zero-order diffraction light beam in the straight direction and to converge the first-order diffraction light beam,
wherein a zero-order diffraction efficiency of the third region is different from a zero-order diffraction efficiency of the second region.

2. The holographic optical element of claim 1, wherein the zero-order diffraction efficiency of the second region is the same as a zero-order diffraction efficiency of the first region.

3. The holographic optical element of claim 2, wherein the zero-order diffraction efficiency of the third region is greater than the zero-order diffraction efficiency of the first region.

4. The holographic optical element of claim 1, wherein the holograms respectively formed in the first region, the second region, and the third region are formed as concentric circles.

5. The holographic optical element of claim 4, wherein the holograms respectively formed in the first region, the second region, and the third region each have a light-incident surface shaped as a plurality of steps.

6. The holographic optical element of claim 5, wherein directions of the plurality of steps in the second region and the third region are the same.

7. The holographic optical element of claim 5, wherein a direction of the plurality of steps in the first region is different than directions of the plurality of steps in the second region and the third region.

8. The holographic optical element of claim 3, wherein the zero order diffraction efficiencies of the first, second, and third regions are 40%, 40%, and 70%, respectively.

9. A compatible optical pickup device compatible with a first information storage medium and a second information storage medium having different thickness, comprising:
a light source to emit light;
a holographic optical element having holograms in regions to diffract the light emitted from the light source into a zero-order diffraction light beam and a first-order diffraction light beam, the holographic element comprising:
a first region to transmit the zero-order diffraction light beam in a straight direction and to diverge the first-order diffraction light beam,
a second region to transmit the zero-order diffraction light beam in the straight direction and to converge the first-order diffraction light beam, and
a third region to transmit the zero-order diffraction light beam in the straight direction and to converge the first-order diffraction light beam, wherein a zero-order diffraction efficiency of the third region is different from a zero-order diffraction efficiency of the second region, and
an objective lens to focus the light to the first information storage medium and the second information storage medium,
wherein the zero-order diffraction light beam passing through the holographic optical element is focused on the first information storage medium, and the first-order diffraction light beam diverging from the first region of the holographic optical element is focused on the second information storage medium.

10. The compatible optical pickup device of claim 9, wherein the first information storage medium is a Blu-ray disk (BD), and the second information storage medium is a high definition-DVD (HD-DVD).

11. The compatible optical pickup device of claim 9, wherein the zero-order diffraction efficiency of the second region is the same as a zero-order diffraction efficiency of the first region.

12. The compatible optical pickup device of claim 11, wherein the zero-order diffraction efficiency of the third region is greater than the zero-order diffraction efficiency of the first region.

13. The compatible optical pickup device of claim 12, wherein a phase difference between the light passing through the hologram formed in the third region and the light passing through the hologram formed in the second region is no more than 20°.

14. The compatible optical pickup device of claim 9, wherein the holograms in the first region, the second region, and the third region are formed as concentric circles.

15. The compatible optical pickup device of claim 14, wherein the holograms formed in the first regions, the second region, and the third region each have a light-incident surface shaped as a plurality of steps.

16. The compatible optical pickup device of claim 15, wherein directions of the plurality of steps in the second region and the third region are the same.

17. The compatible optical pickup device of claim 15, wherein a direction of the plurality of steps in the first region is different than directions of the plurality of steps in the second region and the third region.

18. The compatible optical pickup device of claim 12, wherein the zero order diffraction efficiencies of the first, second, and third regions are 40%, 40%, and 70%, respectively.

19. A compatible optical pickup device compatible with a first information storage medium and a second information storage medium having different thickness, comprising:
a light source to emit light; and
an objective tens to focus the light emitted from the light source on the first information storage medium and the second information storage medium, wherein a holographic optical element is formed on a surface of the objective lens in regions to diffract the light into a zero-order diffraction light beam and a first-order diffraction light beam, the holographic optical element comprising:
a first region to transmit the zero-order diffraction light beam in a straight direction and to diverge the first-order diffraction light beam,
a second region to transmit the zero-order diffraction light beam in the straight direction and to converge the first-order diffraction light beam, and
a third region to transmit the zero-order diffraction light beam in the straight direction and to converge the first-order diffraction light beam,
wherein a zero-order diffraction efficiency of the third region is different from a zero-order diffraction efficiency of the second region, the zero-order diffraction light beam passing through the holographic optical element is focused on the first information storage medium, and the first-order diffraction light beam diverging from the first region of the holographic optical element is focused on the second information storage medium.

20. The compatible optical pickup device of claim 19, wherein the first information storage medium is a BD, and the second information storage is an HD-DVD.

21. The compatible optical pickup device of claim 19, wherein a zero-order diffraction efficiency of the second region is the same as a zero-order diffraction efficiency of the first region.

22. The compatible optical pickup device of claim 21, wherein the zero-order diffraction efficiency of the third region is greater than a zero-order diffraction efficiency of the first region.

23. The compatible optical pickup device of claim 22, wherein a phase difference between the light passing through the hologram formed in the third region and the light passing through the hologram formed in the second region is no more than 20°.

24. The compatible optical pickup device of claim 19, wherein the holograms in the first region, the second region, and the third region are formed as concentric circles.

25. The compatible optical pickup device of claim 24, wherein the holograms formed in the first region, the second region, and the third region each have a light-incident surface shaped as a plurality of steps.

26. The compatible optical pickup device of claim 25, wherein directions of the plurality of steps in the second region and the third region are the same, and a direction of the plurality of steps in the first region is different than the directions of the plurality of steps in the second region and the third region.

27. The holographic optical element of claim 22, wherein the zero order diffraction efficiencies of the first, second, and third regions are 40%, 40%, and 70%, respectively.
